(19) United States
(12) Patent Application Publication
(10) Pub. No.: US 2007/0181671 A1
(43) Pub. Date: Aug. 9, 2007

(54) System, method and computer program product for updating a reference magnetic signature of a magstripe card

(75) Inventors: Michael Donovan, Flanders, NJ (US); Michael J. Mulder, Princeton, NJ (US); Douglas R. Myers, Phoenix, AZ (US); Ian R. Webb, Darien, CT (US)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Company, Inc., New York, NY (US)

(21) Appl. No.: 11/349,239

(22) Filed: Feb. 8, 2006

(51) Int. Cl. G06K 5/00; G07F 19/00

(52) U.S. Cl. 235/380; 235/379

(57) ABSTRACT

The present invention provides systems, methods and computer program products for updating a reference magnetic signature of a magstripe card. In one embodiment, magnetic signatures from a magstripe card, each previously captured from a terminal during a transaction are retrieved from a database. The magnetic signatures are examined to identify if the magnetic properties of the magstripe card have changed. If a change is detected, a new reference magnetic signature is selected and/or created based on the magnetic signatures examined to identify the change and assigned to the magstripe card.

### CROSS REFERENCE TO RELATED APPLICATIONS

This application is related to commonly owned, co-pending U.S. Application No. ______(Attorney Docket Number 2348.0200001), filed on the same date herewith, entitled “System, Method And Computer Program Product For POS-Based Capture Of Reference Magnetic Signatures,” which is incorporated herein by reference in its entirety.

### BACKGROUND OF THE INVENTION

1. Field Of The Invention

The present invention generally relates to fraud detection, and more particularly to fraud detection of an instrument having a magnetic stripe.

2. Related Art

Cards having a magnetic stripe (magstripe) are commonly used today for a variety of purposes. Such cards include charge cards, credit cards, debit cards, identification cards, and access passes. Data stored on a magstripe of a card can be read at a terminal by swiping the card's magstripe past a reading head of the terminal. Once read, the data may be used as part of a system to identify the card holder, perform a financial exchange, or perform a variety of other transactions.

Unfortunately, magstripe cards are vulnerable to counterfeiting. Data from a magstripe of a genuine card may be copied onto a magstripe of a counterfeit card. Once copied, the counterfeit card can be used in place of the genuine card to perform fraudulent transactions such as making fraudulent purchases. In some cases, data from a genuine card is copied using an illegal card reader, known as a skimmer, when the card is provided, for example, to a dishonest clerk during a purchase at a store or a restaurant.

To counteract counterfeiting, the magnetic properties of a magstripe can be used to distinguish genuine and counterfeit magstripe cards. A magstripe has billions of tiny magnetic particles with varying magnetic properties. The magnetic particles are scattered in a random pattern of various shapes and sizes on a magstripe. Due to the innumerable combinations of properties and spatial placement of magnetic particles on a magstripe, the particles when quantified form a magnetic signature that can uniquely identify each magstripe.

Just as a fingerprint can be used to identify human beings, a magnetic signature can be used to identify a magstripe card. When a magstripe card is swiped during a transaction, a magnetic signature of the card can be captured and compared with a known reference magnetic signature of the card. If the signatures match to within a specified tolerance, the card is considered genuine. Otherwise, the card is suspected as being counterfeit. A system for detecting the authenticity of a magstripe card using its magnetic signature is described in U.S. Pat. 6,098,881 to Deland, Jr. et al. issued on Aug. 8, 2000, and assigned to Mag-Tek, Inc., of Carson, Calif.

The wear and tear associated with the use of a magstripe card can cause the magnetic properties of the magstripe to change and thereby cause the magnetic signature of the card to change as well. Existing systems attempt to account for such changes by periodically updating the reference magnetic signature of a card with a magnetic signature that was most recently captured at a point of sale (POS) terminal. Furthermore, existing systems update the reference magnetic signature based on metrics that account for average wear and tear, such as by counting the number of times a card is swiped, rather than by detecting whether a change in the card's signature actually warrants updating the reference signature. The approach taken by existing systems is problematic because a signature captured at a particular POS terminal may contain anomalies due to various factors such as the age of the terminal equipment, the merchant environment, and the direction in which the card was swiped. Hence, a better approach, which updates a reference magnetic signature of a card only when a significant change in the signature of the card is detected and with a new magnetic signature that most accurately represents the changed card, selected from among a set of recently captured POS signatures, is needed to overcome the disadvantages of existing systems.

Given the foregoing, what is needed is a system, method and computer program product for updating the reference magnetic signature of a card to account for changes in the magstripe of a card.

### BRIEF DESCRIPTION OF THE INVENTION

Systems, methods and computer program products are provided for updating a reference magnetic signature of a magstripe card. In one embodiment, magnetic signatures from a magstripe card, each previously captured from a terminal during a transaction, are retrieved from a database. The magnetic signatures are compared to the reference magnetic signature to identify whether the magnetic properties of the magstripe card have changed. When a change is detected, a new reference magnetic signature is selected and/or created based on the magnetic signatures that were examined to identify the change and the new reference magnetic signature is stored for the magstripe card.

A change in the magnetic properties of a magstripe card may be identified by comparing magnetic signatures of the card recently captured during non-fraudulent transactions with the card's reference magnetic signature. Each magnetic signature is compared with the reference magnetic signature to produce a score ranging from 0 and 1. A score of 1 indicates that a magnetic signature is identical to the reference magnetic signature. A score of 0 indicates that there is no correlation between a magnetic signature and the reference magnetic signature. When the scores of a majority of the magnetic signatures are clustered together in a designated range and/or the majority of scores are less than a designated threshold, such as for example 0.75, an inference is made that the magnetic properties of the card has changed. Scores exhibiting these properties indicate that magnetic signatures, which were recently captured, are consistent with each other but lack some degree of correlation with the reference magnetic signature. These indications suggest a change in the magnetic properties of the magstripe card.

In one embodiment, a new reference magnetic signature is selected by choosing, from among the magnetic signatures examined to identify that the magstripe of a card has changed, the signature that generates the highest score. In another embodiment, a new reference magnetic signature is selected by choosing, from among the magnetic signatures examined to identify that the magstripe has changed, the signature that provides the score closest to the average of the scores.

An advantage of the present invention is that conclusions regarding the authenticity of a magstripe card can be more accurately determined over the life of the card. By updating the reference magnetic signature as described above to reflect the gradual changes of a card's magstripe, fewer false conclusions about the authenticity of the card will be made and thus reduce unnecessary disruptions in the use of the card.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a system diagram of an exemplary environment in which the present invention can be implemented.

FIG. 2 is a flowchart illustrating an exemplary process of authorizing a request having a magnetic signature.

FIG. 3 is a flowchart illustrating an exemplary process of updating a reference magnetic signature.

FIG. 4 is a block diagram of an exemplary computer system useful for implementing the present invention.

### DETAILED DESCRIPTION

I. Overview and Terminology

The present invention is directed to a system, method and computer program product for updating a reference magnetic signature of a magstripe card. In the detailed description of the invention that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

The terms “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

A “transaction account” as used herein refers to an account associated with an open account or a closed account system (as described below). The transaction account may exist in a physical or non-physical embodiment. For example, a transaction account may be distributed in non-physical embodiments such as an account number, frequent-flyer account, telephone calling account or the like. Furthermore, a physical embodiment of a transaction account may be distributed as a financial instrument.

A financial transaction instrument may be traditional plastic transaction cards, titanium-containing, or other metal-containing, transaction cards, clear and/or translucent transaction cards, foldable or otherwise unconventionally-sized transaction cards, radio-frequency enabled transaction cards, or other types of transaction cards, such as credit, charge, debit, pre-paid or stored-value cards, or any other like financial transaction instrument. A financial transaction instrument may also have electronic functionality provided by a network of electronic circuitry that is printed or otherwise incorporated onto or within the transaction instrument (and typically referred to as a “smart card”), or be a fob having a transponder and an RFID reader.

“Open cards” are financial transaction cards that are generally accepted at different merchants. Examples of open cards include the American Express®, Visa®, MasterCard® and Discover® cards, which may be used at many different retailers and other businesses. In contrast, “closed cards” are financial transaction cards that may be restricted to use in a particular store, a particular chain of stores or a collection of affiliated stores. One example of a closed card is a pre-paid gift card that may only be purchased at, and only be accepted at, a clothing retailer, such as The Gap® store.

Stored value cards are forms of transaction instruments associated with transaction accounts, wherein the stored value cards provide cash equivalent value that may be used within an existing payment/transaction infrastructure. Stored value cards are frequently referred to as gift, pre-paid or cash cards, in that money is deposited in the account associated with the card before use of the card is allowed. For example, if a customer deposits ten dollars of value into the account associated with the stored value card, the card may only be used for payments up to ten dollars.

The terms “magstripe card,” “magnetic stripe card,” and/or the plural form of these terms are used interchangeably throughout herein to refer to instruments, including financial transaction instruments, having a magnetic stripe.

The terms “card member,” “card holder,” and/or the plural form of these terms are used interchangeably throughout herein to refer to those persons or entities that own or are authorized to use a transaction account.

II. System

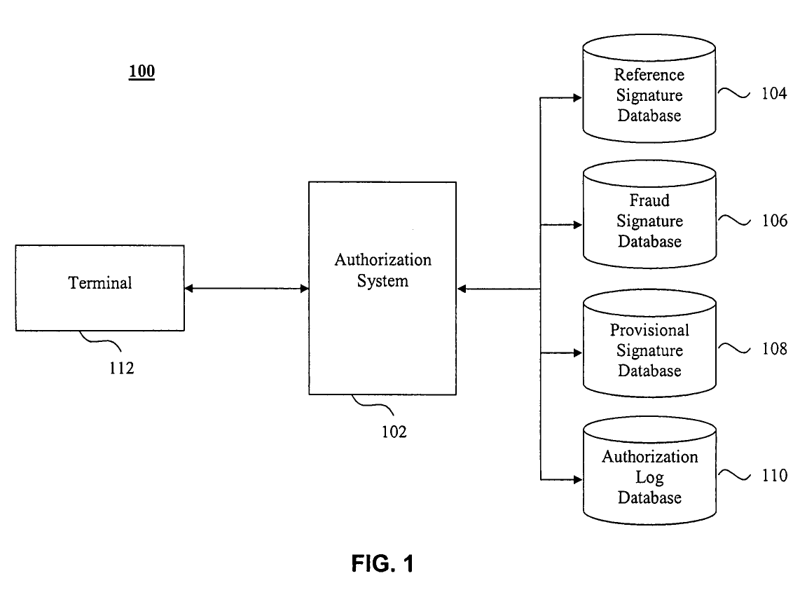

FIG. 1 illustrates a system diagram of an exemplary system 100 in which the present invention can be implemented.

System 100 includes a terminal 112, an authorization system 102, a reference magnetic signature database 104, a fraud signature database 106, a provisional signature database 108, and an authorization log database 110. Terminal 112 interfaces with authorization system 102. Authorization system 102 interfaces with reference magnetic signature database 104, fraud signature database 106, provisional signature database 108, and authorization log database 110. Although databases 104, 106, 108, and 110 are shown separately, as would be appreciated by one skilled in the relevant arts, two or more of the databases 104, 106, 108, and 110 may be implemented as a single database.

Terminal 112 is capable of capturing a magnetic signature from a magstripe card. Terminal 112 may include, for example, a read head (not shown) for capturing a magnetic signature when a magstripe of a card is swiped past the read head. In addition to capturing a magnetic signature, the read head of terminal 112 may also read data from the magstripe. Data read from the magstripe may include transaction account information such as card member name and account number. Terminal 112 may be a computer device operated by a merchant in connection with a transaction such a sale or an identity check, a kiosk such as an automated teller machine (ATM), or any other computing device capable of capturing a magnetic signature from a magstripe card.

Terminal 112 formats a request to authorize a transaction involving a transaction account associated with a magstripe card. The request may include, for example, a magnetic signature, transaction account information, and/or an amount of funds to be transferred, withdrawn or deposited from the transaction account. Information in the request may originate from the magstripe card, a merchant, or from a user of the magstripe card.

Terminal 112 passes the authorization request to authorization system 102. The request may be sent to authorization system 102 over, for example, a telephone network, intranet, the Internet, wireless communications, and/or the like.

Authorization system 102 receives the authorization request from terminal 112 and may return an authorization response to terminal 112. When reference magnetic signature database 104 includes a reference magnetic signature for the magstripe card used to form the request, authorization system 102 may compare the magnetic signature in the request with the reference magnetic signature to determine whether the magstripe card used to form the request is genuine or counterfeit.

When reference magnetic signature database 104 does not include a reference magnetic signature for the magstripe card used to form the request, authorization system 102 may store the magnetic signature provided in the request in provisional signature database 108. A magnetic signature in provisional signature database 108 that is later determined to be non-fraudulent may be added to reference magnetic signature database 104 and used as a reference magnetic signature for a magstripe card in future transactions.

Authorization system 102 may also store magnetic signatures that are determined to be fraudulent in fraud database 106. Magnetic signatures stored in fraud database 106 may be analyzed further to improve the algorithms for distinguishing genuine and fraudulent magnetic signatures.

Authorization system 102 may store authorization requests, including magnetic signatures provided in the requests, in authorization log database 110. Authorization system 102 may use magnetic signatures stored in authorization log database 110 to detect a change in the magnetic properties of a magstripe card, as further described below, and update a reference magnetic signature.

Authorization system 102 makes an authorization decision and sends an authorization response to terminal 112. An authorization response can, for example, approve, deny, or refer the request. If referred, the user of the magstripe card and/or merchant is requested to contact the card issuer, for example, by telephone to provide additional information so that an acceptance decision can be made. In some instances, when an authorization is referred, the user of the magstripe card may be asked, for example, questions to verify that the user is in fact the card owner.

III. Process

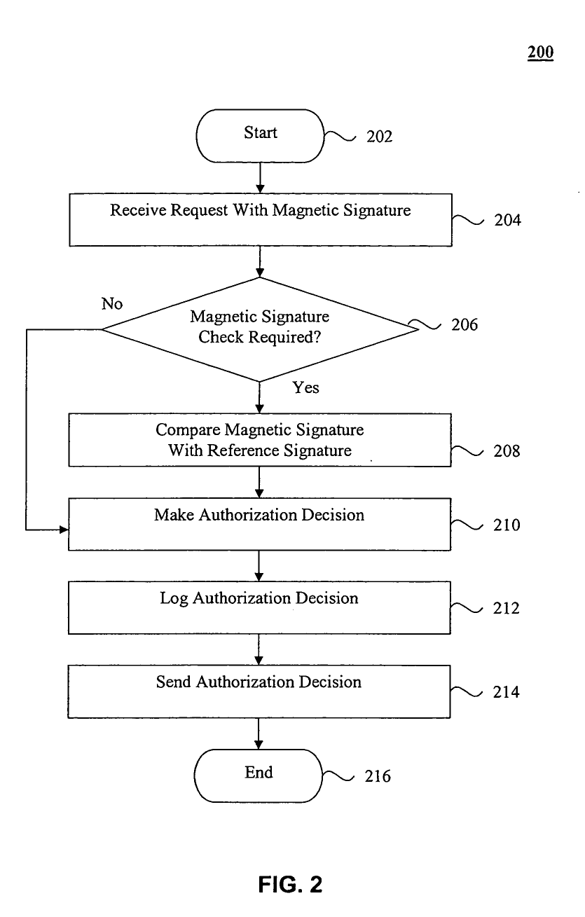

FIG. 2 is a flowchart illustrating an exemplary process 200 for authorizing a transaction request having a magnetic signature. Process 200 begins with step 202 and proceeds to step 204.

In step 204, an authorization request is received from a terminal enabled to capture magnetic signatures, such as terminal 112 as described with respect to FIG. 1. An authorization request may include a magnetic signature of a magstripe card, information identifying an account associated with the magstripe card, and/or information associated with a transaction sought to be performed. Examples of transactions include withdrawal, deposit, transfer, or payment of funds as well as verification of the magstripe card user's identity.

In step 206, a decision is made as to whether magnetic signature based authentication of the magstripe card used to form the request is required. For example, if a reference magnetic signature is not available for the magstripe card associated with the request, no magnetic signature based authentication is possible and therefore it is not required. When a reference magnetic signature is not available, the magnetic signature provided in the request may be stored in a provisional signature database, such as database 108 as described with respect to FIG. 1. As described herein, a magnetic signature in the provisional signature database, once verified as being non-fraudulent, may be assigned as a reference magnetic signature of the magstripe card associated with the request. In another example, if the magstripe card associated with the request is already flagged as being stolen, then no additional authenticity check of the magstripe card is required.

If a magnetic signature based authentication is not required, process 200 proceeds to step 210. Otherwise, process 200 proceeds to step 208.

In step 208, the magnetic signature in the request is compared with a reference magnetic signature to verify the authenticity of the magstripe card used to form the request. A reference magnetic signature is retrieved for the magstripe card associated with the request from a reference magnetic signature database, such as database 104 as described with respect to FIG. 1. The reference magnetic signature is compared with the magnetic signature in the request to determine the degree of correlation between the two signatures. If there is high correlation, then the magstripe card used to form the request is treated as being genuine. If there is low correlation, then the magstripe card used to form the request is treated as being counterfeit or the authenticity check is treated as being inconclusive.

To determine the degree of correlation, the reference magnetic signature may be compared with the magnetic signature in the request to produce a score ranging from, for example, 0 to 1. A score of 1 may indicate that the reference magnetic signature and the magnetic signature in the request are identical. A score of 0 may indicate that there is no correlation between the reference magnetic signature and the magnetic signature in the request. A score between 0 and 1 indicates the degree of correlation between the reference magnetic signature and the magnetic signature in the request. The closer the score is to 1, the more likely it is that the magstripe card used to form the request is genuine. In making a decision as to whether to treat a magnetic signature as being captured from a genuine magstripe card, a threshold value may be used. For example, if a threshold value of 0.75 is utilized, a magnetic signature scoring 0.75 or above would be treated as being captured from a genuine card. A magnetic signature scoring below 0.75 would be treated as either being captured from a fraudulent card or as being inconclusive as to its authenticity. The threshold value used may differ from card member to card member and may change in time for a single card member.

In step 210, an authorization decision is made to approve, deny or refer the request. If a magnetic signature comparison was performed in step 208, the result of the comparison is factored into making the authorization decision. For example, if the comparison reveals that the magnetic signature in the request is likely to have been captured from a fraudulent card, the request is likely to be denied. With each authorization decision, a trade off is made between the risks of approving a fraudulent transaction versus declining a valid transaction. If additional information to approve or deny the transaction is required, a decision may be made to refer the request. When a decision is referred, the merchant or the user of a magstripe card that was used to form the request is asked to contact the card issuer to provide additional details necessary to approve the request.

In step 212, the authorization request and authorization decision are stored in an authorization log database, such as database 110 as described with respect to FIG. 1. As described below, magnetic signatures stored in the authorization log database may be utilized to detect a change in the magnetic properties of a magstripe card and to update the reference magnetic signature of the card.

In step 214, the authorization decision is transmitted to the terminal. The merchant and/or the user will be informed that the request was approved, denied, or referred. If the request is referred, the merchant or the user of the magstripe card may contact the card issuer to have the request approved.

Process 200 completes with step 216.

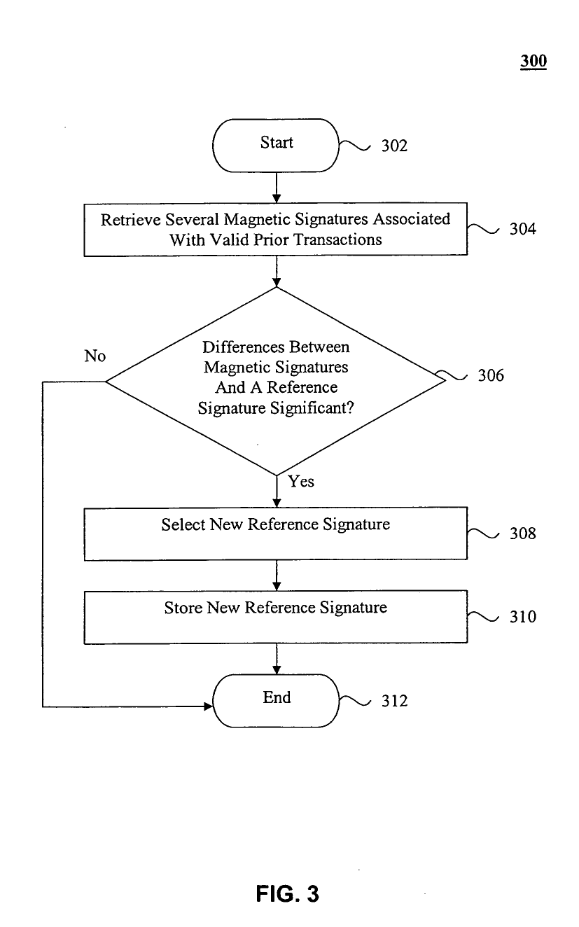

FIG. 3 is a flowchart illustrating an exemplary process 300 for updating an existing reference magnetic signature. Process 300 begins with step 302 and proceeds to step 304.

In step 304, several magnetic signatures, each associated with a magstripe card and each associated with a non-fraudulent transaction, are retrieved from an authorization log database, such as database 110 as described with respect to FIG. 1. Each magnetic signature was captured at a terminal, such as terminal 112 as described with respect to FIG. 1, and provided in a prior request to authorize a transaction. Each magnetic signature was stored in the authorization log database, for example, during a process, such as process 200, to authorize a transaction request associated with the magstripe card.

In step 306, the magnetic signatures retrieved in step 304 are examined to identify differences between the magnetic signatures and the magstripe card's reference magnetic signature to determine whether the magnetic properties of the magstripe card have changed. For example, a score indicating the degree of correlation between a magnetic signature and a reference signature may be obtained for each of the magnetic signatures retrieved in step 304. As described for step 208 of exemplary process 200, a score may range, for example, from 0 to 1 with 0 representing no correlation and 1 representing extremely high correlation. If the majority of scores are all clustered together within a designated range and/or if the majority of the scores are below a designated threshold, such as 0.75, then an inference is made that the magnetic properties of the magstripe card has changed or shifted. Scores exhibiting these properties reveal that although the magnetic signatures captured for the magstripe card are consistent, the magnetic signatures lack a degree of correlation with the reference magnetic signature. These indications suggest that the magnetic properties of the magstripe card have changed to thereby produce slightly different, yet consistent, magnetic signatures.

As would be appreciated by persons skilled in the relevant arts, other techniques and methods may be applied to determine if the magnetic property of the magstripe card has changed by examining magnetic signatures captured from a magstripe card and/or comparing the magnetic signatures with a reference magnetic signature.

If a significant difference between the magnetic signatures retrieved in step 304 and the reference signature is detected to indicate that the magnetic properties of the magstripe card have changed, then process 300 proceeds to step 308. Otherwise, process 300 proceeds to step 314.

In step 308, a reference magnetic signature is selected from among the one or more magnetic signatures retrieved in step 304. In one embodiment, the magnetic signature having the highest correlation with the existing magnetic reference signature is selected as a new reference magnetic signature. In another embodiment, the magnetic signature having the closest score to the average score of the magnetic signatures retrieved in step 304 is selected as a new reference magnetic signature.

In step 310, the new reference magnetic signature selected in step 308 is assigned and stored for the magstripe card.

Process 300 completes with step 312.

### IV. EXAMPLE IMPLEMENTATIONS

The present invention (i.e., system 100, process 200, process 300 or any part(s) or function(s) thereof) may be implemented using hardware, software or a combination thereof and may be implemented in one or more computer systems or other processing systems. However, the manipulations performed by the present invention were often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

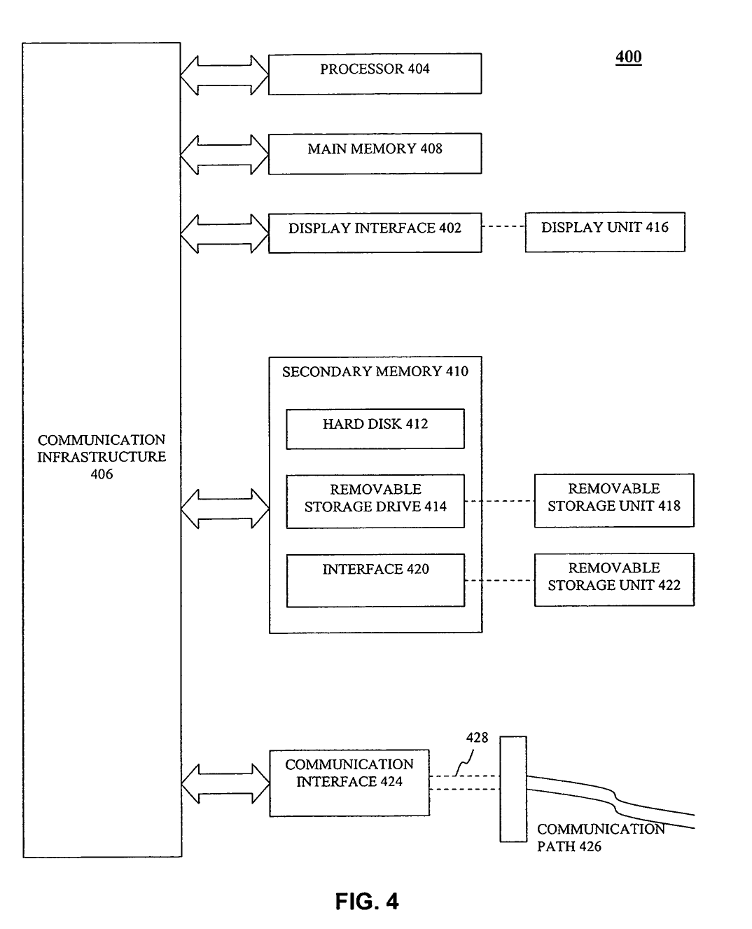

In fact, in one embodiment, the invention is directed toward one or more computer systems capable of carrying out the functionality described herein. An example of a computer system 400 is shown in FIG. 4.

Computer system 400 includes one or more processors, such as processor 404. Processor 404 is connected to a communication infrastructure 406 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 400 can include a display interface 402 that forwards graphics, text, and other data from communication infrastructure 406 (or from a frame buffer not shown) for display on display unit 416.

Computer system 400 also includes a main memory 408, preferably random access memory (RAM), and may also include a secondary memory 410. Secondary memory 410 may include, for example, a hard disk drive 412 and/or a removable storage drive 414, representing a floppy disk drive, a magnetic tape drive, an optical disk drive, etc. Removable storage drive 414 reads from and/or writes to a removable storage unit 418 in a well known manner. Removable storage unit 418 represents a floppy disk, magnetic tape, optical disk, etc. which is read by and written to by removable storage drive 414. As will be appreciated, removable storage unit 418 includes a computer usable storage medium having stored therein computer software and/or data.

In alternative embodiments, secondary memory 410 may include other similar devices for allowing computer programs or other instructions to be loaded into computer system 400. Such devices may include, for example, a removable storage unit 422 and an interface 420. Examples of such may include a program cartridge and cartridge interface (such as that found in video game devices), a removable memory chip (such as an erasable programmable read only memory (EPROM), or programmable read only memory (PROM)) and associated socket, and other removable storage units 422 and interfaces 420, which allow software and data to be transferred from removable storage unit 422 to computer system 400.

Computer system 400 may also include a communications interface 424. Communications interface 424 allows software and data to be transferred between computer system 400 and external devices. Examples of communications interface 424 may include a modem, a network interface (such as an Ethernet card), a communications port, a Personal Computer Memory Card International Association (PCMCIA) slot and card, etc. Software and data transferred via communications interface 424 are in the form of signals 428 which may be electronic, electromagnetic, optical or other signals capable of being received by communications interface 424. These signals 428 are provided to communications interface 424 via a communications path (e.g., channel) 426. This channel 426 carries signals 428 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 414, a hard disk installed in hard disk drive 412, and signals 428. These computer program products provide software to computer system 400. The invention is directed to such computer program products.

Computer programs (also referred to as computer control logic) are stored in main memory 408 and/or secondary memory 410. Computer programs may also be received via communications interface 424. Such computer programs, when executed, enable computer system 400 to perform the features of the present invention, as discussed herein. In particular, the computer programs, when executed, enable processor 404 to perform the features of the present invention. Accordingly, such computer programs represent controllers of computer system 400.

In an embodiment where the invention is implemented using software, the software may be stored in a computer program product and loaded into computer system 400 using removable storage drive 414, hard drive 412 or communications interface 424. The control logic (software), when executed by processor 404, causes processor 404 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### V. CONCLUSION

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method for updating a reference magnetic signature associated with a transaction instrument, comprising the steps of:
retrieving a plurality of magnetic signatures, each being associated with the transaction instrument and captured during a transaction;
identifying at least one difference between the plurality of magnetic signatures and the reference magnetic signature;
selecting a new reference magnetic signature for the transaction instrument based on the plurality of magnetic signatures when the at least one difference is identified; and
storing the new reference magnetic signature;
whereby the new reference magnetic signature may be used as a reference magnetic signature for subsequent transactions.

2. The method of claim 1, wherein the identifying step comprises:
obtaining a score for each magnetic signature in the plurality of magnetic signatures; and
identifying the at least one difference based on a majority of scores being below a designated threshold.

3. The method of claim 2, wherein the identifying step further comprises:
identifying the at least one difference based on a majority of scores being within a designated range of each other.

4. The method of claim 1, wherein the selecting step comprises:
selecting a magnetic signature, from the plurality of magnetic signatures, having the highest correlation with the reference magnetic signature as the new reference magnetic signature.

5. The method of claim 1, wherein the selecting step comprises:
obtaining a score for each magnetic signature in the plurality of magnetic signatures; and
selecting a magnetic signature, from the plurality of magnetic signatures, having a score that is closest to the average score of the plurality of magnetic signatures as the new reference magnetic signature.

6. A system for updating a reference magnetic signature associated with a transaction instrument comprising:
a processor; and
a memory in communication with the processor, wherein the memory stores a plurality of processing instructions for directing the processor to:
retrieve a plurality of magnetic signatures, each being associated with the transaction instrument and captured during a transaction;
identify at least one difference between the plurality of magnetic signatures and the reference magnetic signature;
select a new reference magnetic signature for the transaction instrument based on the plurality of magnetic signatures when the at least one difference is identified; and
store the new reference magnetic signature;
whereby the new reference magnetic signature may be used as a reference magnetic signature for subsequent transactions.

7. The system of claim 6, wherein the processing instructions for directing the processor to identify the difference include instructions for directing the processor to:
obtain a score for each magnetic signature in the plurality of magnetic signatures; and
identify the at least one difference based on a majority of scores being below a designated threshold.

8. The system of claim 7, wherein the processing instructions for directing the processor to identify the difference include instructions for directing the processor to:
identify the at least one difference based on a majority of scores being within a designated range of each other.

9. The system of claim 6, wherein the processing instructions for directing the processor to select the new reference magnetic signature include instructions for directing the processor to:
select a magnetic signature, from the plurality of magnetic signatures, having the highest correlation with the reference magnetic signature as the new reference magnetic signature.

10. The system of claim 6, wherein the processing instructions for directing the processor to select the new reference magnetic signature include instructions for directing the processor to:
obtain a score for each magnetic signature in the plurality of magnetic signatures; and
select a magnetic signature, from the plurality of magnetic signatures, having a score that is closest to the average score of the plurality of magnetic signatures as the new reference magnetic signature.

11. A computer program product comprising a computer usable medium having control logic stored therein for causing a computer to update a reference magnetic signature associated with a transaction instrument, said control logic comprising:
first computer readable program code means for causing the computer to retrieve a plurality of magnetic signatures, each being associated with the transaction instrument and captured during a transaction;
second computer readable program code means for causing the computer to identify at least one difference between the plurality of magnetic signatures and the reference magnetic signature;
third computer readable program code means for causing the computer to select a new reference magnetic signature for the transaction instrument based on the plurality of magnetic signatures when the at least one difference is identified; and
fourth computer readable program code means for causing the computer to store the new reference magnetic signature;
whereby the new reference magnetic signature may be used as a reference magnetic signature for subsequent transactions.

12. The computer program product of claim 11, wherein second computer readable program code means comprises:
fifth computer readable program code means for causing the computer to obtain a score for each magnetic signature in the plurality of magnetic signatures; and
sixth computer readable program code means for causing the computer to identify the at least one difference based on a majority of scores being below a designated threshold.

13. The computer program product of claim 12, wherein second computer readable program code means further comprises:
seventh computer readable program code means for causing the computer to identify the at least one difference based on a majority of scores being within a designated range of each other.

14. The computer program product of claim 11, wherein third computer readable program code means comprises:
fifth computer readable program code means for causing the computer to select a magnetic signature, from the plurality of magnetic signatures, having the highest correlation with the reference magnetic signature as the new reference magnetic signature.

15. The computer program product of claim 11, wherein third computer readable program code means comprises:
fifth computer readable program code means for causing the computer to obtain a score for each magnetic signature in the plurality of magnetic signatures; and
sixth computer readable program code means for causing the computer to select a magnetic signature, from the plurality of magnetic signatures, having a score that is closest to the average score of the plurality of magnetic signatures as the new reference magnetic signature.
